(19) United States
(12) Patent Application Publication
(10) Pub. No.: US 2020/0138652 A1
(43) Pub. Date: May 7, 2020

(54) HEALTHCARE BED

(71) Applicant: MALVESTIO S.P.A., Villanova Di Camposampiero (IT)

(72) Inventor: Marino MALVESTIO, Padova (IT)

(21) Appl. No.: 16/631,021

(22) PCT Filed: Jul. 11, 2018
(86) PCT No.: PCT/EP2018/068813

§ 371 Date: Jan. 14, 2020

(30) Foreign Application Priority Data
Jul. 14, 2017 (IT) 102017000079483

(51) Int. Cl. A61G 7/015; A61G 7/018; A61G 7/005

(52) U.S. Cl. CPC A61G 7/015; A61G 2203/70; A61G 7/005; A61G 7/018

(57) ABSTRACT

A healthcare bed includes a frame surmounted by a lying surface articulated into multiple sections, corresponding to the regions of the back, buttocks, thighs and legs of the patient. The bed includes a fixed part, substantially on the horizontal plane, and a moveable part which supports a first section, corresponding to the back region, which can be at least inclined with respect to the fixed part. Elements for tilting the first section are also included. The bed further includes a second section corresponding to the buttocks region that is pivoted at the side thereof that is adjacent to a third section, corresponding to the thigh region, and is free at the opposite side, there being elements for supporting and moving the second section from a configuration that is coplanar with respect to the lying surface to a configuration that is inclined and with the free side lowered, and vice versa.

### TECHNICAL FIELD

The present disclosure relates to a healthcare bed.

### BACKGROUND

Nowadays numerous types of healthcare beds are known in which the inclination of the support can be adjusted at the back, at the thighs and at the legs, all of which are especially useful for patients with reduced or nil motor capacity.

These beds exhibit some problems.

In order to facilitate the seated positioning of the patient, the backrest is inclined forward, thus causing the slipping of the patient toward the footboard of the bed. The patient therefore has to be repositioned continuously in order to reduce the abdominal compression that obstructs breathing.

In an attempt to solve this problem, beds have been proposed with a backrest that can be moved by roto-translation: while the rotation results in the lifting of the backrest, simultaneously the translation results in its retraction, toward the headboard of the bed, so as to compensate the thrust of the patient toward the footboard.

However, this solution is not sufficient to solve the problem, because the patient seated on the bed is still subject over time to sliding toward the footboard.

### SUMMARY

The aim of the present disclosure is to provide a healthcare bed which is capable of improving the known art in one or more of the above mentioned aspects.

Within this aim, the disclosure provides a bed with which to increase the level of comfort for the in-patient, by reducing his/her slipping toward the footboard of the bed.

The present disclosure further overcomes the drawbacks of the known art in an alternative manner to any existing solutions.

The disclosure also provides a bed that is highly reliable, easy to implement and low cost.

This aim and these and other advantages which will become better apparent hereinafter are achieved by providing a bed according to claim 1, optionally provided with one or more of the characteristics of the dependent claims.

### BRIEF DESCRIPTION OF THE DRAWINGS

Further characteristics and advantages of the disclosure will become better apparent from the description of a preferred, but not exclusive, embodiment of the bed according to the disclosure, which is illustrated by way of non-limiting example in the accompanying drawings wherein:

FIG. 1 is a cross-sectional side view of the bed according to the disclosure with the backrest horizontal on the lying surface;

FIG. 2 is a cross-sectional side view of the bed according to the disclosure with the backrest inclined;

FIG. 3 is a cross-sectional side view of the bed according to the disclosure with the backrest more inclined than in the previous figure;

FIG. 4 is a perspective view of a portion of the bed according to the disclosure; and

FIG. 5 is another perspective view of a portion of the bed according to the disclosure.

### DETAILED DESCRIPTION OF THE DRAWINGS

With reference to the figures, the bed according to the disclosure, generally designated by the reference numeral 10, comprises:
a frame 11 surmounted by a lying surface 12 which is articulated into multiple sections 13, 14, 15, 16, corresponding to the regions of the back, buttocks, thighs and legs of the patient, and comprising a fixed part 17, substantially on the horizontal plane, and a moveable part 18 which supports a first section 13, corresponding to the back region, which can be at least inclined with respect to the fixed part 17,
means 19 for tilting the first section 13.

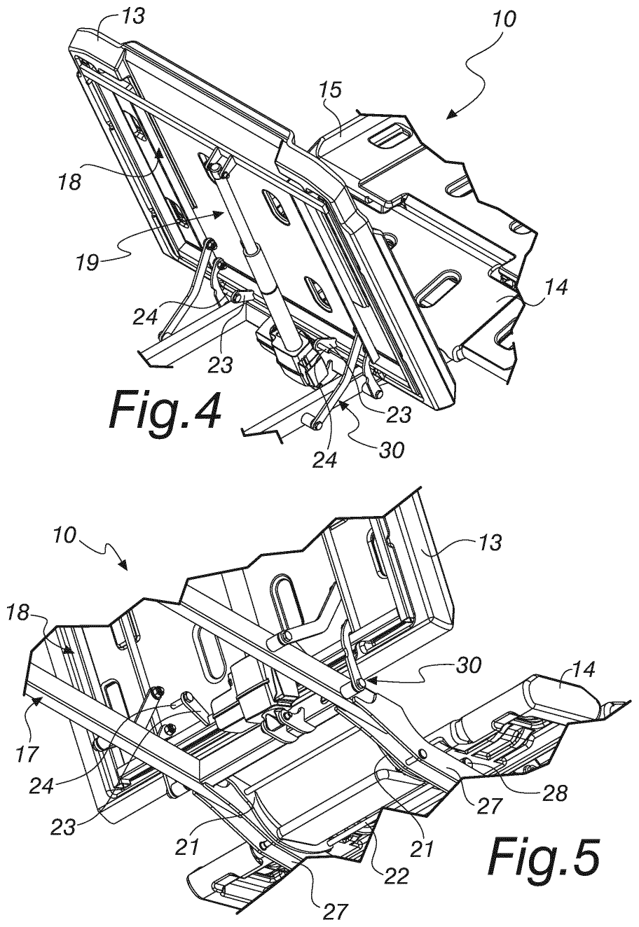

The tilting means 19 comprise an electric actuator installed behind the first section 13, substantially a piston connected at one end to the first section 13 and at the other end to the fixed part 17, as shown in FIG. 4.

The frame 11 is intended to be installed on a conventional supporting structure not shown in the accompanying figures.

A second section 14, corresponding to the buttocks region, is advantageously pivoted at the side thereof that is adjacent to a third section 15, corresponding to the thigh region, and is free at the opposite side, there being means 20 for supporting and moving the second section 14 from a configuration that is coplanar with respect to the lying surface 12 to a configuration that is inclined and with the free side lowered, and vice versa.

The supporting and moving means 20 comprise:
a pair of rockers 21, which are arranged symmetrically on opposite longitudinal sides of the fixed part 17 of the frame 11,
a connecting bar 22, visible and designated in the perspective view in FIG. 5, which is coupled between the two similar ends of the pair of rockers, and which supports the second section 14,
a pair of symmetrical cantilevered brackets 23, which protrude from opposite sides of the moveable part 18 of the frame 11 and are integral therewith, each bracket 23 being provided with a pin 24 which is designed to rest on the end of the respective rocker 21 that lies opposite the end to which the connecting bar 22 is connected, thus preventing the free rotation of the respective rocker 21.

The brackets 23 are clearly visible with the pin 24 in the perspective views and, as can be seen, the pin 24 protrudes in a cantilever fashion from the respective bracket 23 parallel to the plane of the backrest (first section 13) toward the outside of the bed in order to rest on the rocker 21.

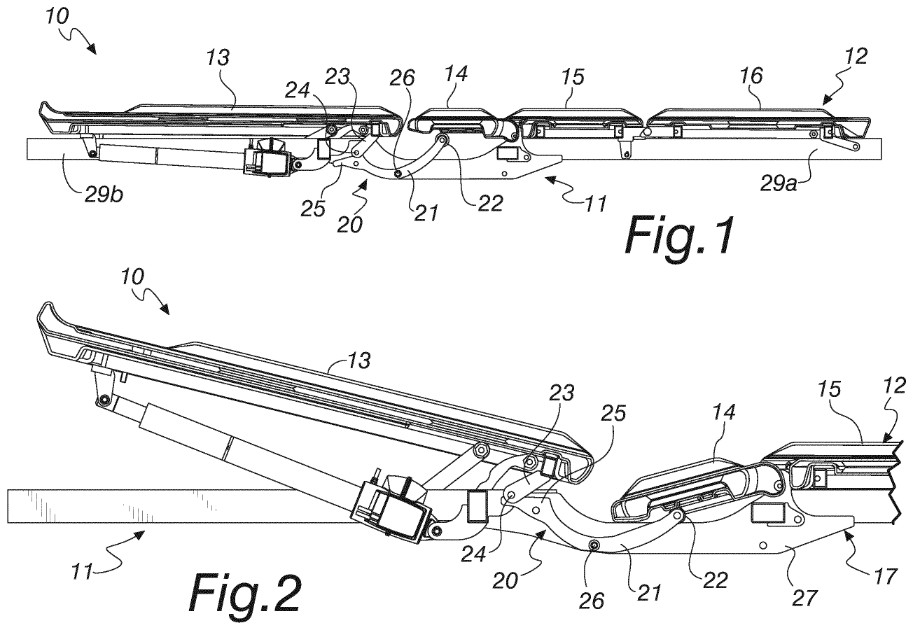

In the views shown in FIGS. 1 to 3, the rocker 21 can clearly be seen. It can be seen that each rocker 21 has a flat end portion 25 on which the pin 24 (shown in these views with its end coupled to the bracket 23) slides during the rotation of the moveable part 18.

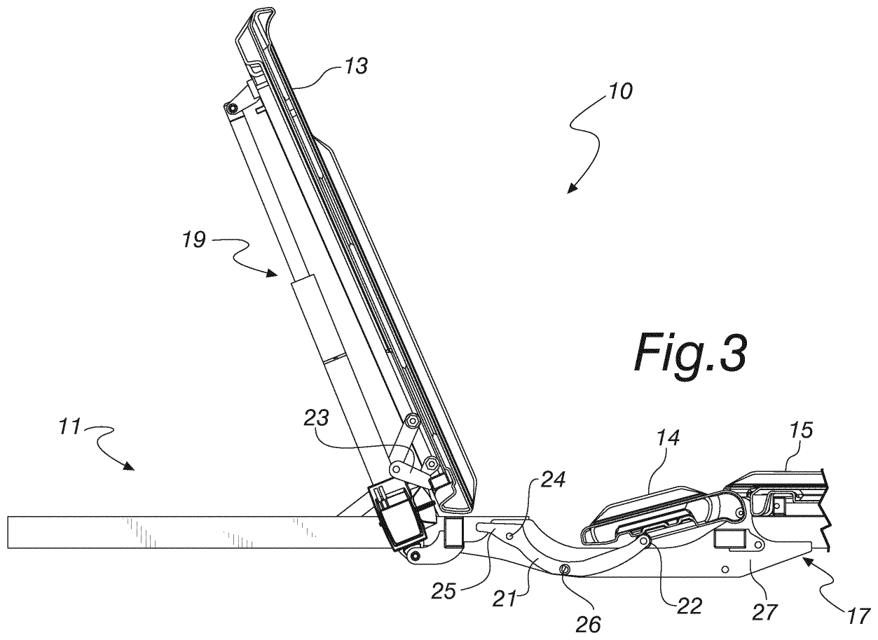

As can be seen from an examination of these figures in sequence, the pin 24 is substantially adapted to slide on the portion 25 during the rotation of the moveable part 18, thus allowing the rotation of the rocker 21 about its pivoting point 26. After a certain inclination, the pin 24 is not resting on the portion 25, as shown in FIG. 3, continuing its rotation integrally with the first section 13.

At the opposite end of the two rockers 21, the connecting bar 22 includes a roller which is adapted to slide below the second section 14 during the tilting of the moveable part 18.

The fixed part 17 of the frame 11 comprises a pair of parallel longitudinally-extended elements 27 on which the connecting bar 22 rests with its end portions 28 (as shown in FIG. 5) in the position of maximum inclination of the second section 14, preventing the further rotation of the latter.

The fixed part 17 of the frame 11 also comprises a first pair of parallel longitudinal members 29a in the region that corresponds to the third section 15 and to the fourth section 16, and another pair of parallel longitudinal members 29b in the region that corresponds to the first section 13. The two pairs of longitudinal members 29 are connected by interposing the pair of longitudinally-extended elements 27 between them.

The bed 10 conveniently comprises means 30 for translating the first section 13 toward the headboard of the bed, which act simultaneously with the tilting means 19.

The translation means 30 comprise a kinematic mechanism, constituted by brackets for connection between the fixed part 17 of the frame 11 and the moveable part 18 (clearly visible in FIG. 4 and in FIG. 5), which, with the rotation induced by the electric actuator, guide the first section 13 in translation toward the headboard.

Operation of the bed according to the disclosure is the following.

When the bed is in the fully extended configuration, as shown in FIG. 1, the brackets 23 rest on the end portion 25 of the respective rockers 21 in the position closest to the pivoting point 26.

In this manner the rockers 21 are kept in the position shown, with the opposite end, where the connecting bar 22 is present, at a height that is such as to keep the second section 14, which rests thereon, on the lying surface 12.

When the first section 13 (the backrest) is tilted, as shown in FIG. 2, the bracket 23 rotates integrally with the first section 13, sliding the pin 24 on the end portion 25 of the rocker 21 to the furthest position with respect to the pivoting point 26.

During the movement of the pin 24 on the end portion 25, the rocker 21 rotates about the pivoting point 26: the part with the flat end portion 25 is lifted, while the portion connected to the connecting bar 22, i.e. the roller, which during this operation rotates below the second section 14, supporting it, is lowered.

The pin 24 resting on the end portion 25 prevents the rocker 21 from rotating except after its movement along the end portion 25.

Beyond a certain inclination of the first section 13, the end portions 28 of the connecting bar 22 rest on the longitudinally-extended elements 27, preventing a further rotation of the rockers 21, as can be seen in FIG. 3 and in the perspective view in FIG. 5.

Furthermore, during the inclination of the first section 13, the translation means 30 cause its translation toward the headboard.

Substantially the bed 10 makes it possible, by tilting the backrest, to create a deepening of the mattress in the buttocks region, with the controlled rotation of the second section 14, which is supported by the connecting bar 22 both in the extended configuration and in the inclined configurations.

In practice it has been found that the disclosure fully achieves the intended aim and objects by providing a bed that is capable of increasing the level of comfort for the in-patient, by reducing his/her slipping toward the footboard of the bed by way of creating a controlled deepening in the buttocks region.

The disclosure, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102017000079483 from which this application claims priority are incorporated herein by reference.

1-8. (canceled)

9. A healthcare bed comprises:
a frame surmounted by a lying surface which is articulated into multiple sections, corresponding to the regions of the back, buttocks, thighs and legs of the patient, and comprising a fixed part, substantially on the horizontal plane, and a moveable part which supports a first section, corresponding to the back region, which can be at least inclined with respect to said fixed part, and
means for tilting said first section,
wherein a second section, corresponding to the buttocks region, is pivoted at a side thereof that is adjacent to a third section, corresponding to the thigh region, and is free at an opposite side, there being means for supporting and moving said second section from a configuration that is coplanar with respect to said lying surface to a configuration that is inclined and with the free side lowered, and vice versa.

10. The bed according to claim 9, wherein said supporting and moving means comprise:
a pair of rockers arranged symmetrically on opposite longitudinal sides of said fixed part of said frame,
a connecting bar coupled between two similar ends of said pair of rockers and supports said second section, and
a pair of symmetrical cantilevered brackets protruding from opposite sides of said moveable part of said frame and are integral therewith, each bracket being provided with a pin configured to rest on the end of the respective said rocker that lies opposite an end to which said connecting bar is connected, thus preventing a free rotation of the respective said rocker.

11. The bed according to claim 10, wherein each of said rockers has a flat end portion on which said pin slides during the rotation of said moveable part.

12. The bed according to claim 10, wherein said connecting bar includes a roller configured to slide below said second section during the tilting of said moveable part.

13. The bed according to claim 10, wherein said fixed part comprises a pair of parallel longitudinally-extended elements on which said connecting bar rests with its end portions in a position of maximum inclination of said second section, preventing a further rotation of said second section.

14. The bed according to claim 13, wherein each of said rockers is pivoted, at an intermediate point thereof, to a respective one of said longitudinally-extended elements.

15. The bed according to claim 9, wherein said tilting means comprise at least one electric actuator.

16. The bed according to claim 9, further comprising means for translating said first section towards the headboard of the bed.
